(19) United States
(12) Patent Application Publication
(10) Pub. No.: US 2011/0019714 A1
(43) Pub. Date: Jan. 27, 2011

(54) OVERMOLDED TEMPERATURE SENSOR AND METHOD FOR FABRICATING A TEMPERATURE SENSOR

(76) Inventor: Loren R. Perry, Fountain Valley, CA (US)

Correspondence Address: LAW OFFICES OF LARRY K. ROBERTS, INC., 2 Park Plaza, Suite 300, Irvine, CA, 92614, US

(21) Appl. No.: 12/509,343

(22) Filed: Jul. 24, 2009

(51) Int. Cl. G01K 1/08; G01K 7/22; B29C 45/14

(52) U.S. Cl. 374/183; 374/208; 264/272.14; 374/E07.028; 374/E01.011

(57) ABSTRACT

An exemplary embodiment of a temperature sensor includes housing, and a solid state temperature sensing device disposed within the housing. A first wiring conductor makes electrical connection from outside the housing to a first terminal of the sensing device. A second wiring conductor makes electrical connection outside the housing to a second terminal of the device. The housing is an over-molded plastic structure encapsulating the sensing device and portions of the first and second wiring conductors. The plastic structure is fabricated of a thermally conductive material. A method for fabricating a temperature sensor positioning a sensor assembly including an elongated circuit board, a solid state sensing device mounted to a tip of the circuit board, and a portion of a cable assembly electrically connected to the circuit board within a mold assembly defining a housing cavity. Molten plastic material is injected into the housing cavity to encapsulate the circuit board, the solid state sensing device and the portion of the cable assembly. The plastic material is thermally conductive and electrically non-conductive. The molten plastic material cools to form a housing structure protecting the sensing device.

### BACKGROUND

Bathing installations typically include a heater assembly connected in a recirculating water flow path, with a pump to circulate water through the heater and typically a filter. A temperature sensor is typically used to monitor a temperature of the bathing installation or a component of the system. For example, a temperature sensor can be placed on or near the heater assembly, or at other locations adjacent the water flow path.

U.S. Pat. No. 6,407,469 describes an exemplary temperature sensor construction.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an exploded diagrammatic view of an exemplary embodiment of a solid state temperature sensor.

FIG. 2 is a top view of the exemplary temperature sensor of FIG. 1.

FIG. 2A is a cross-sectional view taken along line 2A-2A of FIG. 2.

FIG. 3 is a side view of the temperature sensor of FIG. 1, with phantom lines illustrating positioning of the temperature sensing circuit within an overmolded head portion of the sensor.

FIG. 4 is an end view of the sensor of FIG. 3.

FIG. 5 is an isometric view of the cable assembly and temperature sensing circuit of the sensor of FIG. 1, prior to overmolding a plastic sensor head housing over the temperature sensing circuit. FIG. 5A is an exploded view of an exemplary circuit board and solid state sensing element of the temperature sensing circuit.

FIGS. 6 and 7 are top and side views of the device of FIG. 5.

FIG. 8 is a diagrammatic exploded isometric view illustrative of an exemplary over-molding process for fabricating a temperature sensor.

FIG. 9 is an isometric view of an exemplary heater assembly employing temperature sensors.

FIG. 10 is a cross-sectional view illustrating features of the heater assembly of FIG. 9.

### DETAILED DESCRIPTION

In the following detailed description and in the several figures of the drawing, like elements are identified with like reference numerals. The figures are not to scale, and relative feature sizes may be exaggerated for illustrative purposes.

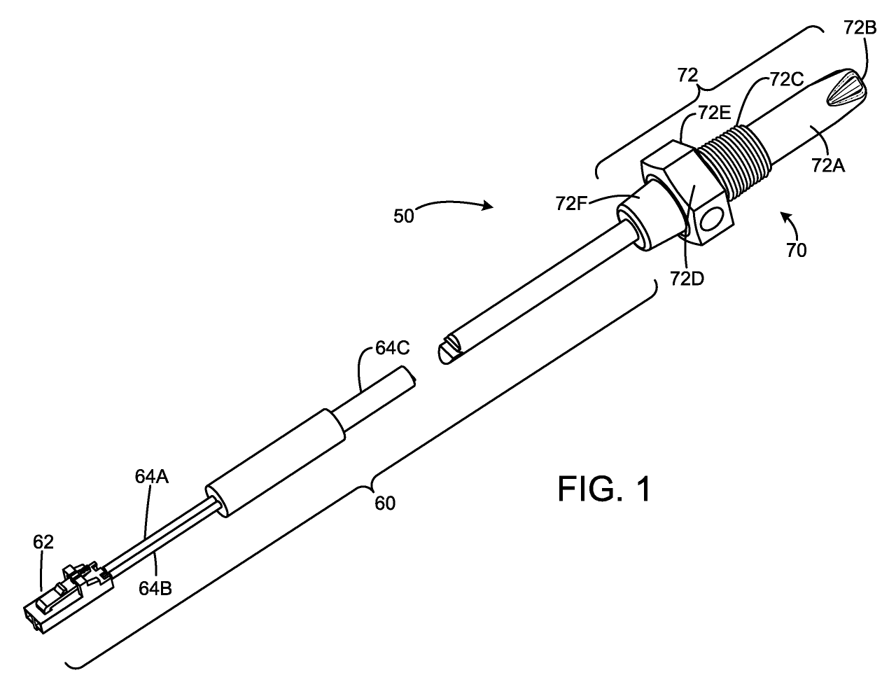

An exemplary embodiment of a solid state temperature sensor 50 is illustrated in FIGS. 1-7. The sensor includes a cable assembly 60 connecting to a sensor head 70. The cable assembly 60 includes a connector 62 electrically connected to connector ends of insulated wires 64A and 64B. Distal sensor circuit ends of the wires are connected to the temperature sensitive element. An outer flexible insulator layer 64C may be used to further insulate and protect the wires.

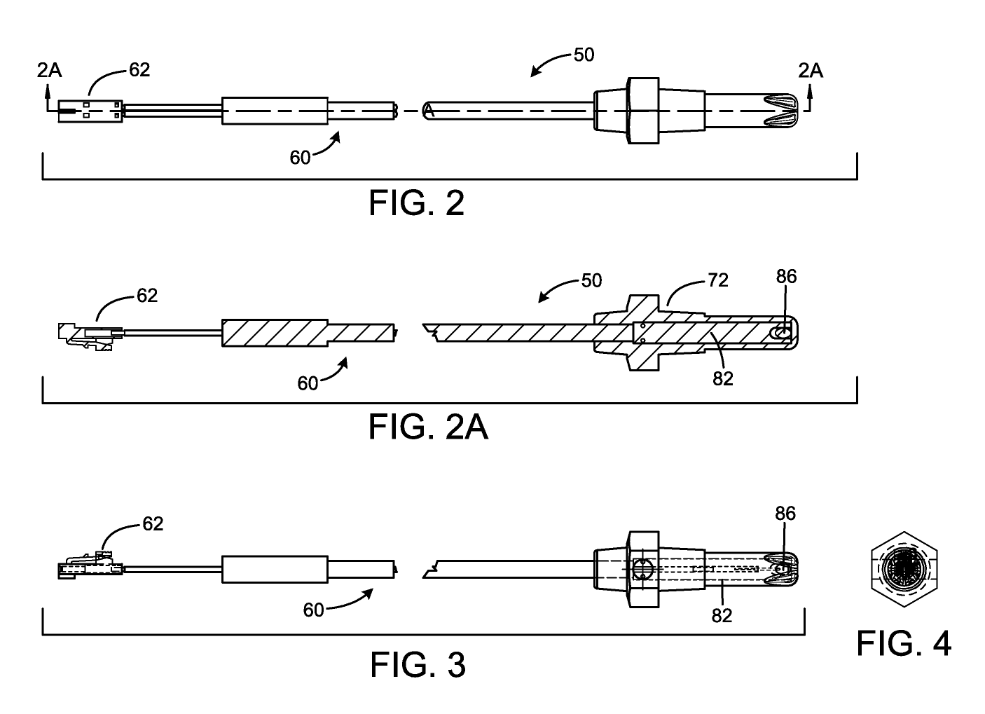

Referring now to FIGS. 1-2, the sensor head 70 includes an outer housing structure 72, which is formed by injection molding a thermally conductive plastic housing over a temperature sensing circuit. This over-molding fabrication process may eliminate the use of a potting material to encapsulate a sensor circuit within a housing, and the problems associated with encapsulation. As shown, the housing structure includes a generally cylindrical probe portion 72A, a probe tip end 72B, and a portion 72C of generally cylindrical configuration which may be threaded to engage a threaded bore in a bathing installation, e.g. a heater assembly. The head portion 70 further includes a hexagonal portion 72D with opposed flat surfaces, which may be engaged by a wrench or tool to turn the sensor in a threaded bore. The hexagonal portion has a cross-sectional dimension larger than that of the portion 72C, and defines a transverse stop surface 72E. An elastomeric seal member (not shown in FIG. 1) such as an o-ring may be positioned against the surface 72E and compressed between the surface 72E and a surface of the heater assembly or other feature of the bathing installation. A transition portion 72F extends toward the connector end of the cable assembly and is molded over the wiring.

The tip end 72B terminates in a reduced cross-sectional dimension. The tip end is reduced in size to bring the temperature sensitive device, e.g. a thermistor, closer to the surface, thereby improving the response time of the sensor. The reduced cross section at the tip of the sensor where the thermistor is located, reduces the mass around the thermistor and makes it more responsive to temperature changes. In an exemplary embodiment, the tip of the sensor has a “+” or “X” shape which also increases turbulence around the tip of the sensor, enhancing the thermal response by increasing the contact area with the water flowing past it, breaking any laminar effects that would exist with a simple rounded tip.

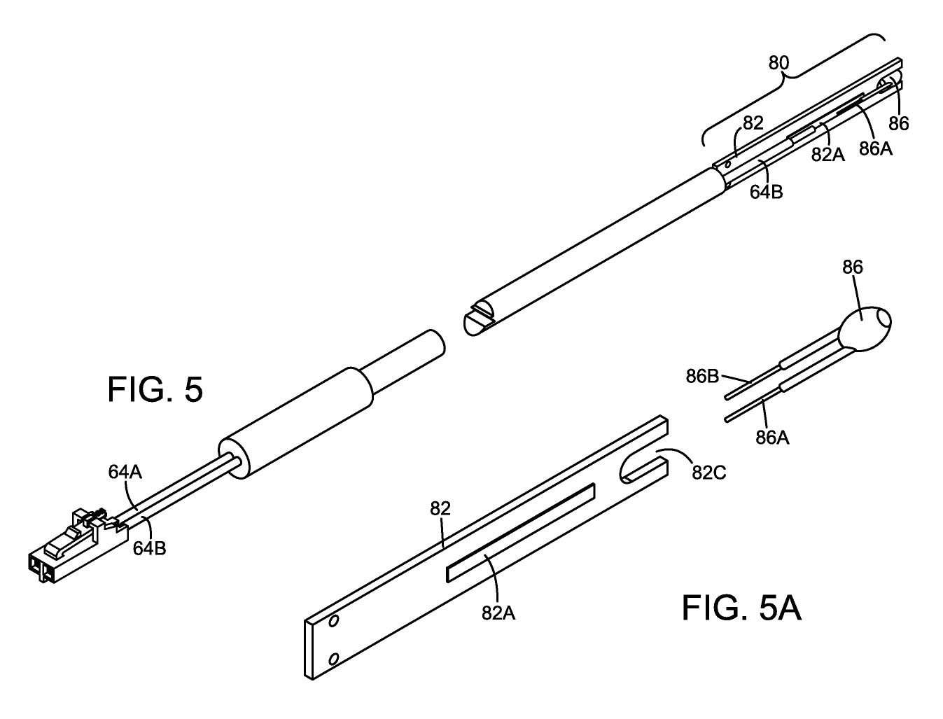

The sensor includes a temperature sensing circuit assembly 80, which includes an elongated, thin dielectric circuit board 82. Thin conductive strips are formed on opposite sides of the circuit board; one such strip 82A is visible in FIG. 5. The circuit board has A sensor tip end of the board has a relieved notch area 82C. A solid state temperature sensitive device 86 is mounted within the notch area of the circuit board, and has two wire leads 86A, 86B extending from the temperature sensitive area. Preferably, the body of the device 86 does not protrude beyond the end of the circuit board by more than a predetermined small distance, e.g. no more than 0.03 inch. The two wire leads are soldered to the respective conductive strips on opposite sides of the circuit board. FIG. 5 illustrates exemplary wire lead 86A soldered to strip 82A.

The sensor ends of the wires 64A, 64B of the cable assembly are also connected to a conductor strip on the circuit board 82, on opposite side thereof. The circuit board may be disposed between the wires 64A, 64B, with the exposed tips of the wires soldered to the respective conductor strips. FIG. 5 illustrates exemplary wire 64B having its tip soldered to one end of the conductor strip 82A, and the wire lead 86A of the device 86 being soldered to the opposed end of the conductor strip 82A. The wire 64A is similarly soldered to the conductor strip on the opposed surface of the circuit board 82. In this manner, the cable assembly is in electrically continuity with the solid state device 86, so that there is a series circuit formed by wire 64B, device 86 and wire 64A.

The solid state temperature sensing device 86 can be implemented by various types of devices, including thermistors, thermocouples, temperature-sensing diodes wherein leakage currents are temperature-dependent, or constant current source circuits wherein the current is temperature-dependent. In an exemplary embodiment, the device 86 is a thermistor. The thermistor device is a thermally sensitive resistor and has, according to type, a negative or positive resistance/temperature coefficient. When used in a sense circuit, the variation in current through the device or voltage drop across the device may be measured as an indication of variation in temperature.

The connector 62 can be inserted in a corresponding connector receptacle on a controller circuit board to establish a sense circuit. For example, one pin or terminal of the connector 62 can be connected to a +5 VDC supply node on the controller circuit board. The second terminal of the connector 62 may be connected to ground through a resistor. The device 86 and the sense resistor thus form a voltage divider circuit, with the voltage across the connector 62 terminals dependent on the variable resistance of the thermistor. The voltage across the connector may be converted to a digital value by an analog-to-digital converter (ADC) and monitored by the controller or microcomputer on the controller circuit board. Since the resistance values of the thermistor 86 varies precisely with its temperature, the voltage across the connector can be converted to temperature readings. Of course, the temperature sensor 50 can be used with other sense circuits.

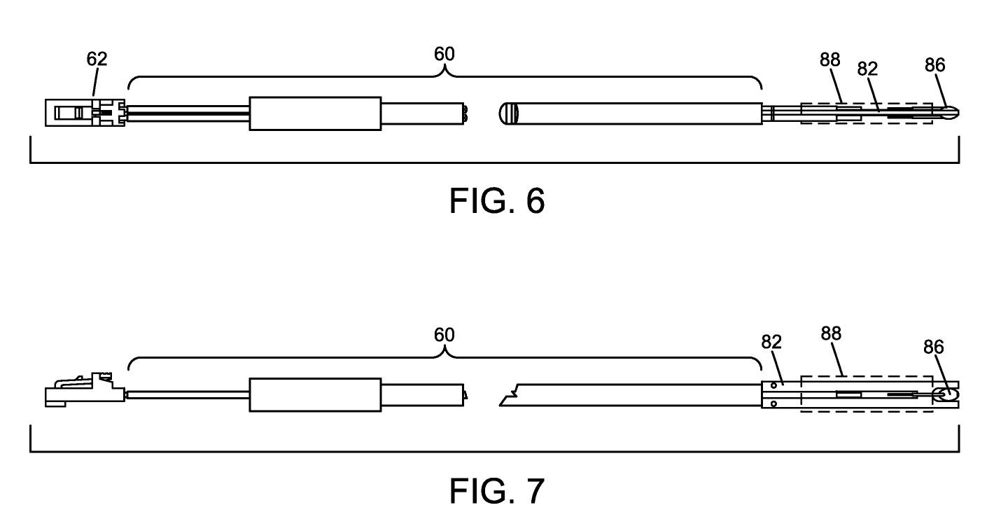

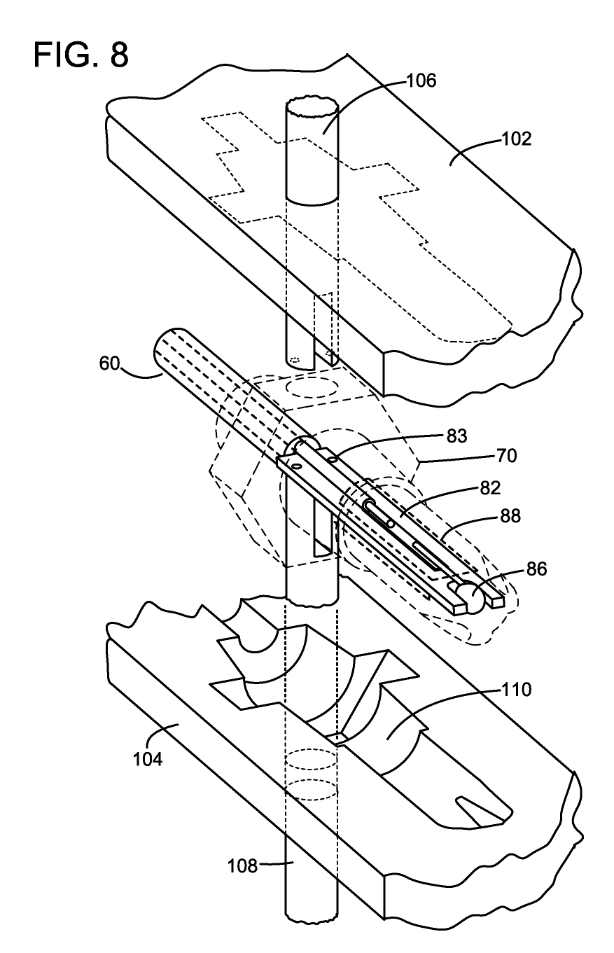

In an exemplary embodiment, a length of thin wall shrink tubing is positioned over a portion of the length of the circuit board 82, covering the soldered wire ends and the conductor strips on the circuit board. FIGS. 6 and 7 depict a shrink tubing 88 in dashed lines. The tubing is heated, and the distal end of the tubing is adjacent the bottom of the notch 82C in the circuit board after shrinking. The tubing does not cover or partially extend over the sensor 86, in an exemplary embodiment. For example, the tubing may be a length of PTFE shrink tube, 0.015 inch wall thickness, and 1 inch in length. The user of shrink tube is a novel approach to holding the leads of the thermistor in place during the overmolding process. These leads are typically used in a through-hole application, and in this exemplary assembly, they are laying flat on the board and are not inserted into holes.

The temperature of the plastic during a molding process may be close to the melt point of the solder used to make the electrical connections to the circuit board conductor strips. Preferably, the solder used to make the electrical connections is a high temperature solder with a higher melt point than the temperature to which the solder joint is subjected during the overmolding process. One exemplary solder is a Sn95, Sb05 solder. If the solder is melted during the molding, there is a risk of one or both leads of the thermistor coming away from the circuit board resulting in a failed assembly. The shrink-tube holds the leads in place during the mold process even if the solder melts and reflows.

In an exemplary embodiment, the shrink tubing may serve two purposes. First, it holds the wires in contact with the solder joints, if reflow should occur during molding. Second, it provides a barrier between the molten plastic and the solder joints to reduce the temperature seen by the solder joints and therefore reduce the possibility of reflow. The shrink tubing does not extend over the temperature sensitive device or thermistor, in an exemplary embodiment, since that would tend to insulate the device from the sensed media, e.g. water or other fluid.

The assembly shown in FIGS. 6 and 7 is then processed through an over-molding step or steps to fabricate the housing structure 70 covering the sensor head. Mold halves 102, 104 define a cavity (generally depicted as 110) which creates the outer shape and configuration of the housing 70. Core pins 106, 108 fix the position of the circuit board 82 in the mold halves, and include features which capture the holes 83 to register the position of the circuit board and sensor. When the mold is closed, the circuit board is clamped in place, and held while molten plastic is injected or introduced into the cavity under pressure to surround the circuit board 82, tubing 88, the end of the cable assembly 60 and sensor 86. The plastic is allowed to cool, and the mold halves and core pins are separated, to allow removal or ejection of the sensor assembly from the mold halves. Voids defined by the core pins may be left open, exposing the circuit board at the pin contact points. Alternatively, the voids may be closed, by partial withdrawal of the pins at the end of the injection cycle to allow plastic to back fill the voids left by the pins, thus encapsulating the circuit board completely.

Suitable thermally conductive plastics are also preferably electrical insulators, and include a polyphenylene sulfide with a filler to add thermal conductivity. Suitable materials are marketed by Cool Polymers, Inc., Warwick, R.I., as D-series CoolPoly® thermally conductive polymers.

A sensor as described herein can have any number of uses, and is particularly suited to applications that require a temperature sensing device that is immune to a wide variety of adverse environments. The environment to be sensed can be a liquid, such as for example water in a bathing installation heater assembly, but does not have to be a liquid. The sensor may be employed to sense air or other gas temperature.

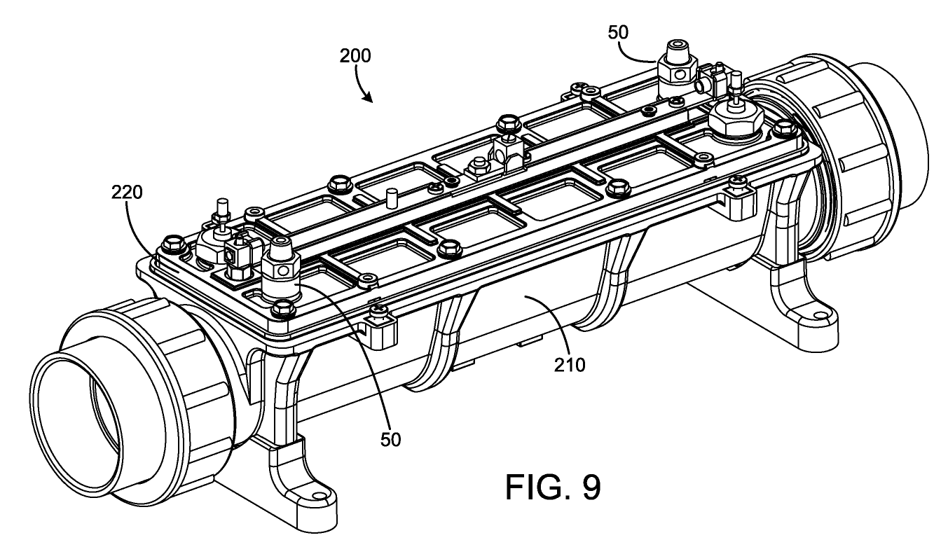

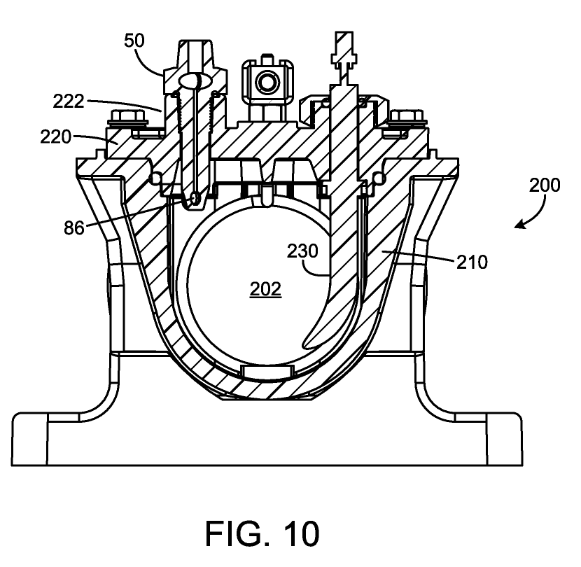

FIGS. 9 and 10 illustrate a bathing system heater 200, as an exemplary application for a temperature sensor 50. The heater 200 is suitable for connection in a recirculating water flow path of a spa, pool or whirlpool bath, for example. The heater assembly is described more fully in co-pending application entitled BATHING INSTALLATION HEATER ASSEMBLY, attorney docket number 2180, the entire contents of which are incorporated herein by this reference. In a general sense, the heater 200 includes a housing structure 210 and a cover plate 220, which assemble together to provide a heater cavity 202 in which an electrically powered heater element 230 is disposed. In this exemplary heater assembly, two temperature sensors 50 are employed, at each ends of the cavity. The sensors may be received in threaded bosses, e.g. boss 222 (FIG. 10), formed in the cover plate, such that the temperature sensitive element 86 is positioned within the cavity, and the overmolded housing structure is exposed to water flowing through the heater 200. The sensor signals may be processed by a controller of the bathing systems, e.g. a microcomputer. Of course, for other applications, only one temperature sensor may be employed. The sensor may be employed in any application utilizing a temperature sensor, including, by way of example only, and without limitation, automotive applications such as engine coolant, ambient air temperature, oil and transmission fluid temperature sensing, and heating/air conditioning applications.

Although the foregoing has been a description and illustration of specific embodiments of the subject matter, various modifications and changes thereto can be made by persons skilled in the art without departing from the scope and spirit of the invention as defined by the following claims.

What is claimed is:

1. A temperature sensor, comprising:
a housing;
a solid state temperature sensing device disposed within said housing;
a first wiring conductor for making electrical connection from outside the housing to a first terminal of said device;
a second wiring conductor for making electrical connection outside the housing to a second terminal of said device; and
wherein the housing is an over-molded plastic structure encapsulating the sensing device and portions of said first and second wiring conductors, the plastic structure fabricated of a thermally conductive, electrically non-conductive material.

2. The sensor of claim 1, further comprising:
an elongated dielectric circuit board; and
wherein the temperature sensing device is mounted at a distal end of said circuit board adjacent a tip of the housing.

3. The sensor of claim 2, wherein the circuit board includes first and second conductor strips on opposed sides of the circuit board, the first terminal of the sensing device is electrically connected to the first conductor strip, the second terminal of the sensing device is electrically connected to the second conductor strip, the first wiring conductor is electrically connected to the first conductor strip and the second wiring conductor is electrically connected to the second conductor strip.

4. The sensor of claim 3, further comprising a length of shrink tubing covering a portion of the circuit board and the electrical connections, and without covering a temperature sensitive region of the sensing device.

5. The sensor of claim 3, wherein the electrical connections are solder connections, and the solder is a high melt point solder.

6. The sensor of claim 1, wherein the temperature sensing device is a thermistor.

7. The sensor of claim 1, wherein the housing includes a generally cylindrical sensor portion.

8. The sensor of claim 1, wherein the housing includes an exterior threaded portion to engage corresponding threads in a sensor receptacle.

9. The sensor of claim 1, further comprising a connector secured to distal ends of the first and second wiring conductors, the connector providing a removable electrical connection to a sensing circuit.

10. The sensor of claim 1, wherein said housing has a tip region, and the solid state temperature sensing device is disposed in said tip region, and wherein the tip region has a reduced cross-sectional configuration which is reduced in size relative to a configuration of an intermediate region of the housing to bring the temperature sensing device close to an exterior surface of the tip region, thereby improving the response time of the sensor.

11. The sensor of claim 10, wherein the cross-sectional configuration of the tip region has a shape which increases turbulence of a fluid around the tip of the sensor, enhancing the thermal response by increasing a contact area with the fluid flowing past it, and breaking laminar effects.

12. The sensor of claim 1, wherein the housing is free of any potting material.

13. A heater assembly for a bathing installation, including a housing structure, a heater element, and a temperature sensor as recited in claim 1 mounted to the housing structure.

14. A method for fabricating a temperature sensor, comprising:
positioning a sensor assembly including an elongated circuit board, a solid state sensing device mounted to a tip of the circuit board, and a portion of a cable assembly electrically connected to the circuit board within a mold assembly defining a housing cavity;
injecting a molten plastic material into the housing cavity to encapsulate the circuit board, the solid state sensing device and the portion of the cable assembly, and wherein the plastic material is thermally conductive and electrically non-conductive;
allowing the molten plastic material to cool to form a housing structure protecting the sensing device;
removing the cooled housing structure from the mold cavity.

15. The method of claim 14, wherein said positioning step includes:
clamping the circuit board between a pair of core pins to register a molding position of the circuit board and the sensing device;
closing a first mold half and a second mold half about the sensor assembly to define the mold cavity.

16. The method of claim 14, wherein the mold cavity defines an exterior threaded region of the housing.

17. The method of claim 14, wherein the temperature sensor is free of potting material encapsulating the sensing device and circuit board.

18. The method of claim 14, further comprising fabricating the sensor assembly, comprising:
mounting the solid state sensing device to the circuit board by soldering first and second leads of the device to respective first and second conductive strips on opposed sides of the circuit board at a connection region of the circuit board; and
soldering first and second conductor wire ends of the cable assembly to the first and second conductive strips in said connection region.

19. The method of claim 18, wherein said fabricating the sensor assembly further comprises:
positioning a length of shrink tubing surrounding the connection region without covering a temperature sensitive region of the sold state sensing device, so that the soldered first and second leads and the soldered first and second conductor wire ends are covered by the shrink tubing before the sensor assembly is placed in the mold assembly.

20. The method of claim 18, wherein said soldering of said first and second leads and said first and second conductor wire ends to said circuit board conductive strips includes:
using solder with a high melting temperature.

21. The method of claim 14, wherein said housing structure has a tip region, and the solid state temperature sensing device is disposed in said tip region, and wherein the tip region has a reduced cross-sectional configuration which is reduced in size relative to a configuration of an intermediate region of the housing to bring the temperature sensing device close to an exterior surface of the tip region, thereby improving the response time of the sensor.

22. The method of claim 21, wherein the cross-sectional configuration of the tip region has a shape which increases turbulence of a fluid around the tip of the sensor, enhancing the thermal response by increasing a contact area with the fluid flowing past it, and breaking laminar effects.
